(19) United States
(12) Patent Application Publication
(10) Pub. No.: US 2025/0254654 A1
(43) Pub. Date: Aug. 7, 2025

(54) OPTIMIZING RAN NOTIFICATION AREA (RNA) UPDATE AND RAN PAGING USING USER EQUIPMENT (UE) MOBILITY HISTORY INFORMATION

(71) Applicant: Rakuten Symphony, Inc., Tokyo (JP)

(72) Inventors: Santhiyaku Jeevakumar ANTONYRAJ, Bangalore, Karnataka (IN); Bhanu Prakash PILLALA, Bangalore, Karnataka (IN)

(73) Assignee: Rakuten Symphony, Inc., Tokyo (JP)

(21) Appl. No.: 18/689,630

(22) PCT Filed: Jan. 11, 2024
(86) PCT No.: PCT/US2024/011228

§ 371 Date: Mar. 6, 2024

(30) Foreign Application Priority Data
Sep. 29, 2023 (IN) 202341065688

(51) Int. Cl. H04W 68/02; H04W 48/08

(52) U.S. Cl. CPC H04W 68/02; H04W 48/08

(57) ABSTRACT

Embodiments of the present disclosure disclose determining priority cell list based on mobility history information of UE. The RIC receives the mobility history information and subscriber ID of the UE from a base station. Further, the RIC stores the mobility history information against the subscriber ID of the UE. Thereafter, the RIC determines the priority cell list based on the mobility history information of the UE for optimizing RNA update and RAN paging.

### TECHNICAL FIELD

The present disclosure generally relates to communication technologies, and more specifically, optimizing Radio Access Network (RAN) Notification Area (RNA) update and RAN paging using User Equipmet (UE) mobility history information.

### BACKGROUND

In Third Generation Partnership Project (3GPP), since release-15 (Rel-15), the 3GPP has specified the Radio Resource Control (RRC)_INACTIVE state in UE, allowing the UE context to be suspended in the RAN and resume anytime the UE wants to return to an active state. The UE may continue to move throughout a list of cells designated as the “RAN Notification Area” while it is INACTIVE. The UE may remain INACTIVE without sending any signals to the RAN as long as it is travelling within these cells and has no data to relay. Further, success of this method/technique depends on how well the RNA is optimized and fine-tuned.

In view of the above discussion, there exists a need to optimize RNA-updates for the UE using mobility history information of the UE to reduce the number of paging.

The information disclosed in this background of the disclosure section is only for enhancement of understanding of the general background of the disclosure and should not be taken as an acknowledgement or any form of suggestion that this information forms the prior art already known to a person skilled in the art.

### SUMMARY

In an embodiment, a Radio Access Network (RAN) Intelligent Controller (RIC) is disclosed. The RIC includes a memory and a processor. The memory is configured to store instructions and thereby causes the RIC to: receive mobility history information of a UE and a subscriber identifier (ID) of the UE from a base station. The RIC is configured to store the mobility history information of the UE based on the subscriber ID of the UE. Thereafter, the RIC is configured to determine a priority cell list based on the mobility history information of the UE.

In another embodiment, a method is disclosed. The method includes receiving, by a RIC, mobility history information of a UE and a subscriber ID of the UE from a base station. The method includes storing, by the RIC, the mobility history information of the UE based on the subscriber ID of the UE. The method includes determining, by the RIC, a priority cell list based on the mobility history information of the UE.

In an embodiment, a base station is disclosed. The base station includes a memory and a processor. The memory is configured to store instructions and thereby causes the base station to: receive mobility history information of the UE and a subscriber identifier (ID) of the UE from the UE. The base station is configured to transmit the mobility history information and the subscriber ID of the UE to a RIC. The base station is configured to receive a priority cell list from the RIC. The RIC determines the priority cell list based on the mobility history information of the UE. The base station is configured to perform paging on the priority cell list.

In yet another embodiment, a non-transitory computer readable medium is disclosed. The non-transitory computer readable medium is configured to: receive mobility history information of a UE and a subscriber identifier (ID) of the UE from a base station. The non-transitory computer readable medium is configured to store the mobility history information of the UE based on the subscriber ID of the UE. Thereafter, the non-transitory computer readable medium is configured to determine a priority cell list based on the mobility history information of the UE.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. The same numbers are used throughout the figures to reference like features and components. Some embodiments of device and/or methods in accordance with embodiments of the present subject matter are now described, by way of example only, and with reference to the accompanying figures, in which:

FIG. 1 illustrates a sequence diagram showing interaction with a RIC for determining priority cell list, in accordance with an embodiment of the present disclosure;

FIG. 2 shows a detailed block diagram of a RIC for determining priority cell list, in accordance with an embodiment of the present disclosure;

FIG. 3 illustrates a sequence diagram showing interaction with a base station for performing paging, in accordance with an embodiment of the present disclosure;

FIG. 4 shows a detailed block diagram of a base station for performing paging, in accordance with an embodiment of the present disclosure;

FIG. 5 illustrates a flowchart showing an exemplary method for determining priority cell list, in accordance with an embodiment of the present disclosure; and

FIG. 6 illustrates a flowchart showing an exemplary method for performing paging, in accordance with an embodiment of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration”. Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

It shall be noted that, for convenience of explanation, the disclosure uses terms and names defined in the 3rd Generation Partnership Project Radio Access Network (3GPP RAN) standards. More specifically, the terms ‘Radio Access Network (RAN) Intelligent Controller (RIC)’, ‘base station’, ‘gNodeB’ ‘cell’, ‘User Equipment (UE)’, ‘Near Real-Time RIC (Near-RT RIC)’, ‘RRCSetupComplete’, ‘VarMobilityHistoryReport’, ‘mobilityHistoryavail’, ‘RRCResumeComplete’, ‘RRC_Inactive’, ‘RRC_Idle’, ‘RRC_Connected’, ‘visitedCellInfoList’, ‘RIC subscription request’, ‘UEInformationResponse’, ‘E2 Service Model (E2SM)-RAN Control (RC) Indication message’, ‘New Radio (NR) cells’ etc are to be interpreted as specified by the 3GPP RAN standards and Open Radio Access Network (ORAN) standards.

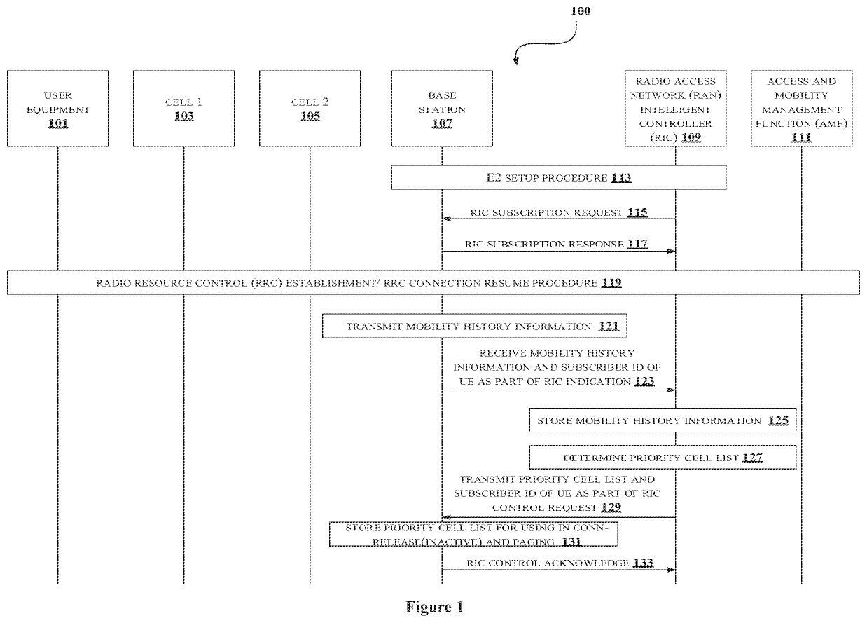

The term “RNA update and RAN paging” as used herein refers to optimizing RNA update and RAN paging using UE mobility history information. More specifically, the mobility history information of the UE and subscriber ID is received from a base station where the UE is connected In an embodiment, the mobility history information is stored against the subscriber ID of the UE. In another embodiment, the mobility history information is utilized to determine priority cell list for optimizing RNA update and RAN paging. The determined priority cell list enables the UE to reduce the RNA-update signalling between the UE and the base station. Further, the priority cell list helps the base station to achieve successful RAN paging with less paging signalling and reduce paging overhead at the base station. In an embodiment, the determining of the priority cell list based on the mobility history information is explained in detail with reference to FIGS. 1-6.

FIG. 1 illustrates a sequence diagram showing interaction with a RIC for determining priority cell list, in accordance with an embodiment of the present disclosure. FIG. 1 shows UE 101, a cell 1 103, a cell 2 105, a base station 107, a RIC 109 and an Access and Mobility Management Function (AMF) 111. In an embodiment, the UE 101 may include, but not limited to, a mobile device, a smartphone, a tablet, a laptop, a wireless device and the like. In an embodiment, the cell 1 103 and the cell 2 105 are geographic area that is covered by the base station 107 in a cellular network. In another embodiment, the UE 101 is connected to the base station 107. In another embodiment, the RIC 109 is a software-defined component of open radio access network that is responsible for controlling and optimizing RAN functions. Initially, an E2 setup procedure 113 is established between the base station 107 and the RIC 109. The base station 107 may include, but not limited to, a gNodeB (gNB), a next-generation evolved NodeB (ng-eNB), evolved NodeB (eNB). In an embodiment, the E2 procedure is performed to establish signaling connection between the E2 node of the base station 107 and the RIC 109. Particularly, the RIC 109 transmits a RIC subscription request message 115 to the base station 107. For example, the RIC 109 transmits [RIC Event trigger definition type 1=Message event, Message type=RRC->NR Message ID=UEInformationResponse] to the base station 107. Upon receiving the RIC subscription request message 115, the base station 107 transmits a RIC subscription response message 117 to the RIC 109. In an embodiment, the RIC subscription response message indicates confirmation of successful subscription procedure at the base station 107 for sending “UEInformationResponse” RRC message.

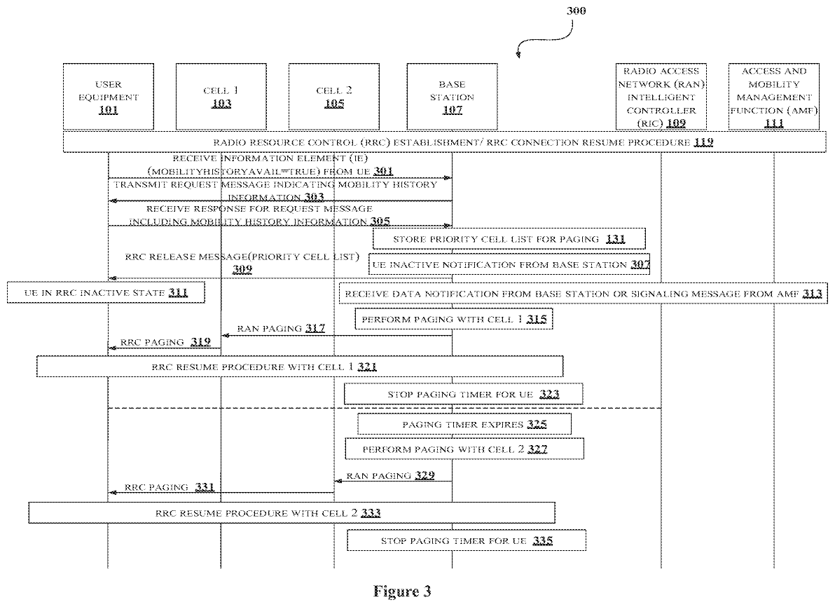

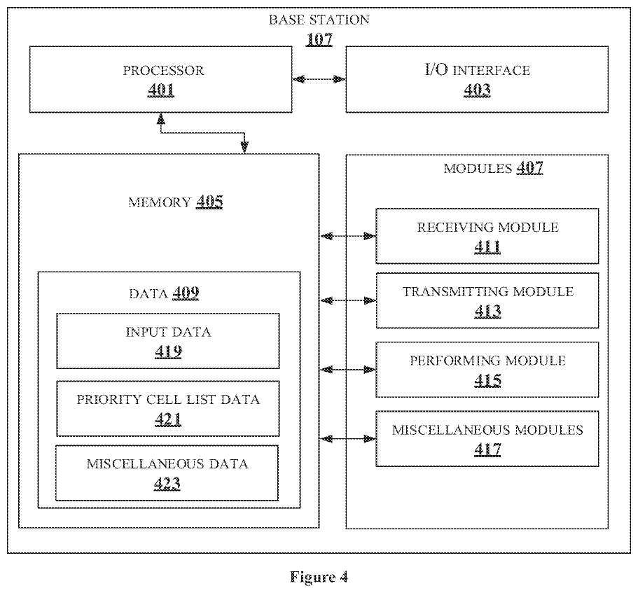

In an embodiment, the UE 101 supports storage of mobility history information, and the UE 101 includes the mobility history information in “VarMobilityHistoryReport”. In an embodiment, the mobility history information includes cells that are visited by the UE 101 during its inactive, idle or connected states. In an embodiment, “mobilityHistoryAvail” is included in a RRCSetupComplete message/RRCResumeComplete message. The “mobilityHistoryAvail” indicates that the UE 101 comprises the mobility history information. In an embodiment, the UE 101 performs RRC establishment/RRC connection resume procedure 119 with the AMF 111. In an embodiment, the RRC establishment/RRC connection resume procedure is explained in detail in FIGS. 3-4. In an embodiment, at 121, the base station 107 transmits the mobility history information to the RIC 109. In an embodiment, at 123, the RIC 109 receives the mobility history information and subscriber ID of the UE 101 from the base station 107 where the UE 101 is connected. In an embodiment, the mobility history information and the subscriber ID are received by the RIC 109 from the base station 107 using one of a first message and a second message via a E2 interface. In an embodiment, the first message and the second message are a standard message of the ORAN. In an embodiment, the mobility history information and the subscriber ID may be transmitted as a part of the first standard message i.e., RIC indication message (Action=report, E2SM-[UEID->5G-S-TMSI, E2SM-RC Indication Message Format 1->RRC Message->RRC UE Information Response]). In case, the mobility history information and the subscriber ID are not a part of the first standard message, then the mobility history information and the subscriber ID are transmitted using the second standard message i.e., RIC indication message using custom E2SM-RC container message via the E2 interface. In an embodiment, the subscriber ID may include, but is not limited to, 5G-STMSI, RAN related identifier and the like. In an embodiment, the subscriber ID is a key for the UE 101 to keep records unique within the RIC 109 as the subscriber ID is unique within the AMF 111 region (5G-S-TMSI{AMFSetId, AMFPointer, TMSI}). In an embodiment, the AMFSetID is an IE that is used to uniquely identify an AMF Set within the AMF region. In an embodiment, the AMFPointer is an IE that is used to identify one or more AMF(s) within the AMF Set. In an embodiment, the 5G-TMSI is unique within the AMF that has allocated it. In an embodiment, the 5G-STMSI is a Temporary Mobile Subscription Identifier (5G-S-TMSI), a temporary UE identity provided by 5G Core (5GC) which uniquely identifies the UE 101 within a tracking area.

In an embodiment, upon receiving the mobility history information, at 125, the RIC 109 stores the mobility history information of the UE 101 based on the subscriber ID of the UE 101. For example, the RIC 109 maps the mobility history information with the subscriber ID of the UE 101. In an embodiment, at 127, the RIC 109 determines a priority cell list based on the mobility history information of the UE 101. In an embodiment, the mobility history information of the UE 101 comprises information regarding one or more cells of a plurality of cells visited by the UE during an inactive state or an idle state or in connected state. In an embodiment, the RIC 109 determines the priority of each of the one or more cells based on the mobility history information. The mobility history information includes amount of time spent by the UE 101 in the one or more cells, number of times the UE 101 visited in the one or more cells and traversal pattern of the UE 101 among the one or more cells. Upon determining the priority cell list, at 129, the RIC 109 transmits the determined priority cell list to the base station 107 via the E2 interface. In an embodiment, the priority cell list is a “RAN notification area information priority list” that is transmitted using the standard message i.e., the priority cell list is included in a “RRC connection release control” within RIC control request message while transmitting to the base station 107 via the E2 interface. In another embodiment, the priority cell list is transmitted along with the subscriber ID to the base station 107 via the E2 interface using the first standard message or using the second standard message (i.e., E2SM-RC container message). For example, while transmitting the priority cell list and the subscriber ID the message may indicate “RIC CONTROL REQUEST (E2SM-RC [UEID->5G-S-TMSI, RRC Connection Release Control->RAN Notification Area Information Priority List]” or “custom E2SM containing [5G-S-TMSI, RAN Notification Area Information Priority List [PLMN, NRCEllIdentity list [Priority, NR-CELLIdentity (1 . . . N)]]]”. Further, the base station 107 stores the priority cell list for paging 131 that is explained in detail in FIGS. 3-4. In an embodiment, once the base station 107 receives the priority cell list, at 133, the base station 107 transmits RIC control acknowledgement message to the RIC 109.

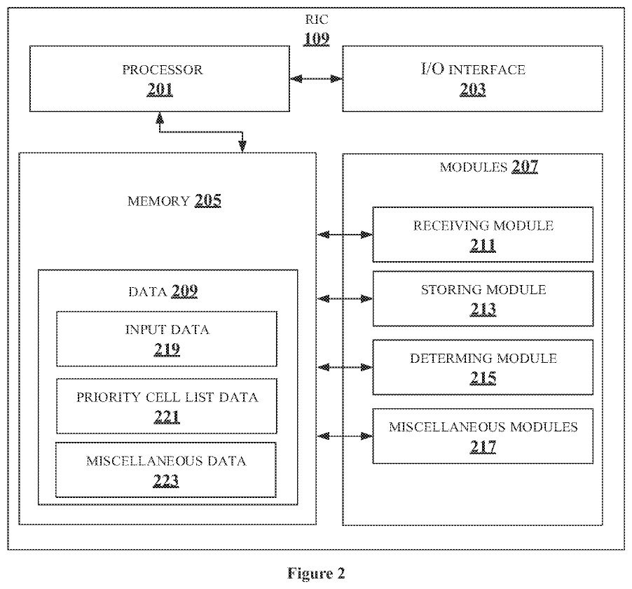

In an embodiment, the RIC 109 may include a processor 201, I/O interface 203, and a memory 205 as shown in FIG. 2. In some embodiments, the memory 205 may be communicatively coupled to the processor 201. The memory 205 stores instructions, executable by the processor 203, which, on execution, may cause the RIC 109 for determining the priority cell list, as disclosed in the present disclosure. In an embodiment, the memory 205 may include one or more modules 207 and data 209 as shown in FIG. 2. The one or more modules 207 may be configured to perform the procedures of the present disclosure using the data 209, for determining the priority cell list. In an embodiment, each of the one or more modules 207 may be a hardware unit which may be outside the memory 205 and coupled with the RIC 109. In an embodiment, the RIC 109 may communicate with the base station 107 via the E2 interface (not shown in FIG. 1).

FIG. 2 shows a detailed block diagram of a RIC for determining priority cell list, in accordance with an embodiment of the present disclosure.

The data 209 and the one or more modules 207 in the memory 205 of the RIC 109 is described herein in detail.

In one implementation, the one or more modules 207 may include, but are not limited to, a receiving module 211, a storing module 213, a determining module 215, and one or more miscellaneous modules 217, associated with the RIC 109.

In an embodiment, the data 209 in the memory 205 may include input data 219, priority cell list data 221, and miscellaneous data 223 associated with the RIC 109.

In an embodiment, the data 209 in the memory 205 may be processed by the one or more modules 207 of the RIC 109. In an embodiment, the one or more modules 207 may be implemented as dedicated units and when implemented in such a manner, said modules may be configured with the functionality defined in the present disclosure to result in a novel hardware. As used herein, the term module may refer to an Application Specific Integrated Circuit (ASIC), an electronic circuit, a Field-Programmable Gate Arrays (FPGA), Programmable System-on-Chip (PSoC), a combinational logic circuit, and/or other suitable components that provide the described functionality.

One or more modules 207 of the present disclosure function to determine the priority cell list. The one or more modules 207 may also include miscellaneous modules 217 to perform various miscellaneous functionalities of the RIC 109. It will be appreciated that such modules may be represented as a single module or a combination of different modules. The one or more modules 207 along with the data 209, may be implemented in any RIC, for determining the priority cell list.

The input data 219 may include information regarding the mobility history information of the UE 101 and the subscriber ID of the UE 101.

The priority cell list data 221 may include details regarding priority of each of the one or more cells determined based on the mobility history information of the UE 101.

The miscellaneous data 223 may store data, including temporary data and temporary files, generated by modules for performing the various functions of the RIC 109.

In an embodiment, the receiving module 211 of the RIC 109 is configured to receive the mobility history information of the UE 101 and the subscriber ID of the UE 101 from the base station 107. The UE 101 is connected to the UE 101. In an embodiment, the mobility history information is included in an Information Element “VisitedCellInfoList”. The mobility history information comprises information of maximum 16 most recently visited primary cells or time spent in any cell selection state and/or camped on any cell state in NR or E-UTRA. In an embodiment, in case of dual connectivity, the mobility history information of maxPSCellHistory most recently visited primary secondary cell group cells across all the primary cells are included in the VisitedCellInfoList. Upon receiving, the storing module 213 of the RIC 109 is configured to store the mobility history information of the UE 101 based on the subscriber ID of the UE 101. In an embodiment, the storing module 213 maps the mobility history information with the subscriber ID of the UE 101. The storing module 213 stores the mapped mobility history information for determining priority cell list. Further, the determining module 215 of the RIC 109 is configured to determine the priority cell list based on the mobility history information of the UE 101. In an embodiment, the determining module 215 determines priority of each of the one or more cells based on the information regarding amount of time spent by the UE 101 in the one or more cells, number of times the UE 101 visited in the one or more cells and traversal pattern of the UE 101 among the one or more cells. Further, in an embodiment, the determined priority cell list and the subscriber ID are transmitted by the RIC 109 to the base station 107 using the first message (i.e., the standard message) or the second message (i.e., the specific message) via E2 interface.

FIG. 3 illustrates a sequence diagram showing interaction with a base station for performing paging, in accordance with an embodiment of the present disclosure. FIG. 3 shows the UE 101, the cell 1 103, the cell 2 105, the base station 107, the RIC 109 and the AMF 111. Initially, the E2 setup procedure 113 is established between the base station 107 and the RIC 109 as explained in above FIG. 1. In an embodiment, the UE 101 performs RRC establishment/RRC connection resume procedure 119 with the AMF 111. In an embodiment, the RRC establishment/RRC connection resume procedure 119 is used to establish/re-establish RRC connection between the UE 101 and the base station 107 after a temporary interruption or suspension. In an embodiment, a trigger for the RRC connection resume is received based on various events such as a cell reselection, handover or transitioning from an idle state to an active state. Further, in an embodiment, the base station 107 generates an RRC connection resume request message which may include relevant information about RRC connection to be resumed. The relevant information may include, but not limited to, context information, security information and the like. Further, the UE 101 processes the received RRC connection resume request message for resuming the connection. Thereafter, the UE 101 acknowledges successful resumption of the RRC connection. Further, the base station 107 receives the acknowledgment from the UE 101, confirming the RRC connection has been successfully resumed. In an embodiment, during the RRC establishment/RRC connection resume procedure, at 301, the base station 107 receives information element (IE) from the UE 101. For example, consider the UE 101 attaches/resumes to a network or the AMF 111 and the UE 101 supports storage of the mobility history information. In this scenario, the UE sends the “mobilityHistoryAvail” IE set to true in “RRCSetupComplete/RRCResumeComplete” message to the base station 107. In particular at 303, the base station 107 requests the UE 101 to share the mobility history information using “UE information request” RRC message with “mobilityHistoryReportReq” IE set to true. Then, the UE 101 sends “mobilityHistoryReport-r16” IE in “UE information response” message to the base station 107. That is, at 305, the base station 107 receives the UE information response message for the request. Further, the base station 107 transmits the mobility history information and the subscriber ID of the UE 101 to the RIC 109 to determine the priority cell list (as described in above FIG. 1). At 131, the base station 107, stores the priority cell list to use in RRC release and for paging. In an embodiment, at 307 and 309, the base station 107 saves the priority cell list locally within “UE inactive context” and transmits the information (i.e., the priority cell list) to the UE 101 as part of “suspendConfig->RAN-notificationAreaInfo->PLMN-RAN-AreaCellList” IE within “RRC release” message. Further, at 311, the UE 101 utilizes the “RNA notification area information” (i.e., the priority cell list) while moving in an inactive state. In an embodiment, if the UE 101 is moving in these priority cell list, the UE 101 does not need to do RNA update procedure with RAN. In an embodiment, as these NRCells are priority visited cells, the UE 101 performs less number of RNA-updates. Thus, achieving less signaling overhead between the UE 101 and the base station 107. In another embodiment, if the UE 101 is in inactive state, the UE 101 may visit multiple NRCells and the UE 101 updates the “VarMobilityHistoryReport” with these new visited cells in its database for sharing with the RAN when the UE 101 moves to connected state later.

In an embodiment, at 313, the base station 107 receives signalling message from the AMF 111 or data notification from the base station 107. For example, if a gNB-CUCP of the base station 107 receives “DL data notification” message from a gNB-CUUP of the base station 107 or if the base station 107 receives any signalling message from the AMF 111 for the UE 101, the base station 107 utilises the stored priority cells list to perform RAN paging in the one or more cells listed with high priority first and starts a paging timer. In an embodiment, the gNB-CUCP (gNB-CU-Control Plane) is a logical node hosting the RRC and control plane part of a Packet Data Convergence Protocol (PDCP) of the base station 107. In an embodiment, the gNB-CUUP (gNB-CU-User Plane) is a logical node hosting user plane part of the PDCP of the base station 107. In an embodiment, if the UE 101 is present in any of the priority cell list, the UE 101 resumes RRC connection with that cell/NR-Cell. In another embodiment, the UE 101 may share updated or latest “mobilityHistoryReport-r16” IE with the current serving base station. In an embodiment, if the paging timer expires, the base station 107 performs the paging with next priority cell from the priority cell list until the paging is successful.

For example, in FIG. 3, upon receiving the signalling message from the AMF 111, at 315, the base station 107 performs paging with the cell 1 103. At 317, the base station 107 performs the RAN paging with the cell 1 103 having the first priority. If the paging is successful with the cell 1 103, at 319, the cell 1 103 perform RRC paging with the UE 101. Thereafter, at 321, the UE 101 resumes RRC connection with the cell 1 103. Once the paging is successful with the cell 1 103, at 323, the base station 107 stops the paging timer for the UE 101. In another embodiment, at 325, if the paging is not successful and the paging timer expires, the base station 107 at 327 performs paging with the cell 2 105. At 329, the base station 107 performs the RAN paging with the cell 2 105 having the second priority. If the paging is successful with the cell 2 105, at 331, the cell 2 105 perform RRC paging with the UE 101. Thereafter, at 333, the UE 101 resumes RRC connection with the cell 2 105. Once the paging is successful with the cell 2 105, at 335, the base station 107 stops the paging timer for the UE 101.

In an embodiment, the base station 107 may include a processor 401, I/O interface 403, and a memory 405 as shown in FIG. 4. In some embodiments, the memory 405 may be communicatively coupled to the processor 401. The memory 405 stores instructions, executable by the processor 401, which, on execution, may cause the base station 107 for performing paging, as disclosed in the present disclosure. In an embodiment, the memory 405 may include one or more modules 407 and data 409 as shown in FIG. 4. The one or more modules 407 may be configured to perform the procedures of the present disclosure using the data 409, for performing paging. In an embodiment, each of the one or more modules 407 may be a hardware unit which may be outside the memory 405 and coupled with the base station 107. In an embodiment, the base station 107 may communicate with the UE 101 and the RIC 109 via the E2 interface (not shown in FIG. 3).

FIG. 4 shows a detailed block diagram of a base station for performing paging, in accordance with an embodiment of the present disclosure.

The data 409 and the one or more modules 407 in the memory 405 of the base station 107 is described herein in detail.

In one implementation, the one or more modules 407 may include, but are not limited to, a receiving module 411, a transmitting module 413, a performing module 415, and one or more miscellaneous modules 417, associated with the base station 107.

In an embodiment, the data 409 in the memory 405 may include input data 419, priority cell list data 421, and miscellaneous data 423 associated with the base station 107.

In an embodiment, the data 409 in the memory 405 may be processed by the one or more modules 407 of the base station 107. In an embodiment, the one or more modules 407 may be implemented as dedicated units and when implemented in such a manner, said modules may be configured with the functionality defined in the present disclosure to result in a novel hardware. As used herein, the term module may refer to an Application Specific Integrated Circuit (ASIC), an electronic circuit, a Field-Programmable Gate Arrays (FPGA), Programmable System-on-Chip (PSoC), a combinational logic circuit, and/or other suitable components that provide the described functionality.

One or more modules 407 of the present disclosure function to perform paging. The one or more modules 407 may also include miscellaneous modules 417 to perform various miscellaneous functionalities of the base station 107. It will be appreciated that such modules may be represented as a single module or a combination of different modules. The one or more modules 407 along with the data 409, may be implemented in any base station, for performing paging.

The input data 419 may include information regarding the mobility history information of the UE 101 and the subscriber ID of the UE 101.

The priority cell list data 421 may include details regarding priority of each of the one or more cells determined based on the mobility history information of the UE 101.

The miscellaneous data 423 may store data, including temporary data and temporary files, generated by modules for performing the various functions of the base station 107.

In an embodiment, the receiving module 411 of the base station 107 is configured to receive the mobility history information of the UE 101 and the subscriber ID of the UE 101 from the UE 101. In an embodiment, the receiving module first receives the information element from the UE 101. The information element indicates availability of the mobility history information. Further, the transmitting module 413 of the base station 107 is configured to transmit a request message to the UE 101 for sharing the mobility history information of the UE 101. In an embodiment, the receiving module 411 receives the mobility history information of the UE in response to the request message. In an embodiment, the mobility history information of the UE 101 comprises information regarding the one or more cells of the plurality of cells visited by the UE 101 during the inactive state or the idle state or in the connected state. Upon receiving, the transmitting module 413 transmits the mobility history information and the subscriber ID of the UE 101 to the RIC 109. In an embodiment, the mobility history information and the subscriber ID of the UE 101 is transmitted from the base station 107 to the RIC 109 using the first message or the second message via the E2 interface. Further, the RIC 109 determines the priority cell list based on the mobility history information as explained above in FIGS. 1-2. In an embodiment, the receiving module 411 of the base station 107 receives the priority cell list from the RIC 109. Thereafter, the performing module 415 of the base station 107 is configured to perform paging based on the priority cell list. In an embodiment, the paging is performed when at least one of signaling message or data is received by the base station 107 for the UE 101 during an inactive state. In an embodiment, a timer may be set for a predefined time period for performing the paging. In an embodiment, the performing module 415 performs the paging in the one or more cells based on at least one of successful paging or the paging in one or more cells based on next highest priority of the priority cell list within the predefined time period.

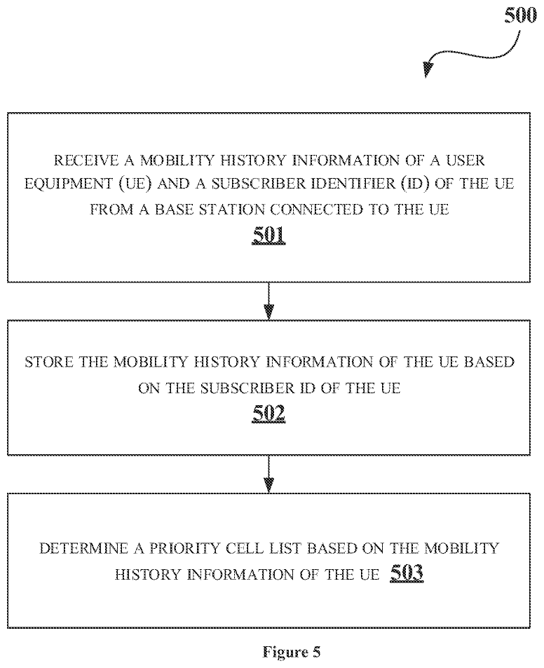

FIG. 5 illustrates a flowchart showing an exemplary method for determining priority cell list, in accordance with an embodiment of the present disclosure.

As illustrated in FIG. 5, the method 500 may include one or more blocks for executing processes in the RIC 109. The method 500 may be described in the general context of computer executable instructions. Generally, computer executable instructions can include routines, programs, objects, components, data structures, procedures, modules, and functions, which perform particular functions or implement particular abstract data types.

The order in which the method 500 is described may not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 501, receiving, the mobility history information of the UE 101 and the subscriber ID of the UE 101 from the base station 107 connected to the UE 101.

At block 502, storing, the mobility history information of the UE 101 based on the subscriber ID of the UE 101.

At block 503, determining, the priority cell list based on the mobility history information of the UE 101.

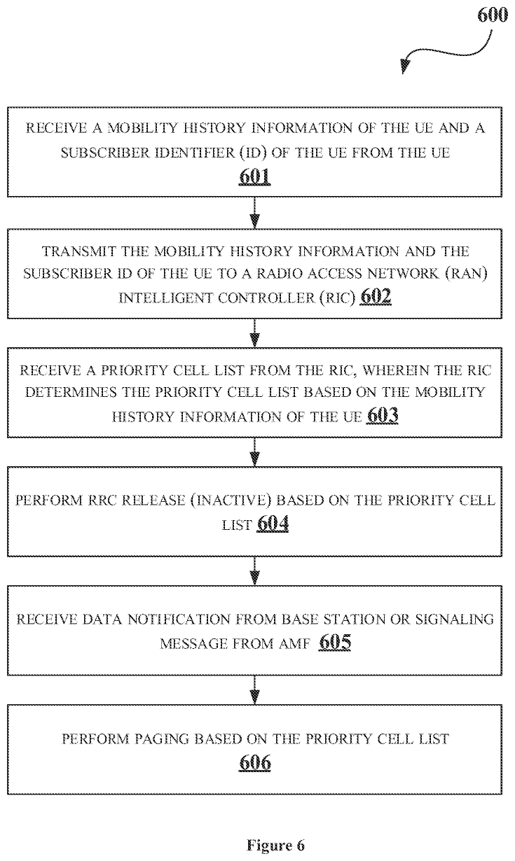

FIG. 6 illustrates a flowchart showing an exemplary method for performing paging, in accordance with an embodiment of the present disclosure.

As illustrated in FIG. 6, the method 600 may include one or more blocks for executing processes in the base station 107. The method 600 may be described in the general context of computer executable instructions. Generally, computer executable instructions can include routines, programs, objects, components, data structures, procedures, modules, and functions, which perform particular functions or implement particular abstract data types.

The order in which the method 600 is described may not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 601, receiving, the mobility history information of the UE 101 and the subscriber ID of the UE 101 from the UE 101.

At block 602, transmitting, the mobility history information and the subscriber ID of the UE 101 to the RIC 109.

At block 603, receiving, the priority cell list from the RIC 109. The RIC 109 determines the priority cell list based on the mobility history information of the UE 101.

At block 604, performing, the RRC release (inactive) based on the priority cell list.

At block 605, receiving, the data notification from the base station 107 or signaling message from the AMF 111.

At block 606, performing, paging based on the priority cell list.

The disclosed method with reference to FIGS. 5-6, or one or more operations of the RIC 109 and the base station 107 explained with reference to FIGS. 1-4 may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device). Such software may be executed, for example, on a single local computer.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD (Compact Disc) ROMs, DVDs, flash drives, disks, and any other known physical storage media.

Various embodiments of the present disclosure provide numerous advantages. Embodiments of the present disclosure enables the UE to reduce the RNA-update signalling between the UE and the base station by utilising updated cell list obtained from the RIC. Further, the priority cell list helps the base station to achieve successful RAN paging with less paging signalling. Thus, the present disclosure reduces paging overhead at the base station. Further, the present disclosure enables the RIC to determine the priority cell list by using the mobility history information of the UE. Further, the present disclosure provides better utilization of Radio Frequency (RF) network resources. The present disclosure provides better UE battery performance.

It will be understood by those within the art that, in general, terms used herein, and are generally intended as “open” terms (e.g., the term “including” should be interpreted as “including but not limited to,” the term “having” should be interpreted as “having at least,” the term “includes” should be interpreted as “includes but is not limited to,” etc.). For example, as an aid to understanding, the detail description may contain usage of the introductory phrases “at least one” and “one or more” to introduce recitations. However, the use of such phrases should not be construed to imply that the introduction of a recitation by the indefinite articles “a” or “an” limits any particular part of description containing such introduced recitation to disclosure containing only one such recitation, even when the introductory phrases “one or more” or “at least one” and indefinite articles such as “a” or “an” (e.g., “a” and/or “an” should typically be interpreted to mean “at least one” or “one or more”) are included in the recitations; the same holds true for the use of definite articles used to introduce such recitations. In addition, even if a specific part of the introduced description recitation is explicitly recited, those skilled in the art will recognize that such recitation should typically be interpreted to mean at least the recited number (e.g., the bare recitation of “two recitations,” without other modifiers, typically means at least two recitations or two or more recitations).

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following detailed description.

We claim:

1. A Radio Access Network (RAN) Intelligent Controller (RIC) (109) comprising:
a memory (205) configured to store instructions executable by a processor (201); and
the processor (201) configured to execute the instructions stored in the memory (205) and thereby cause the RIC (109) to:
receive a mobility history information of a User Equipment (UE) and a subscriber identifier (ID) of the UE from a base station, wherein the base station is where the UE is connected;
store the mobility history information of the UE based on the subscriber ID of the UE; and
determine a priority cell list based on the mobility history information of the UE.

2. The RIC (109) as claimed in claim 1, wherein the processor (201) is configured to:
map the mobility history information with the subscriber ID of the UE; and
store the mapped mobility history information for determining the priority cell list.

3. The RIC (109) as claimed in claim 1, wherein the processor (201) is configured to:
determine the priority cell list based on the mobility history information, wherein the mobility history information of the UE comprises information regarding one or more cells of a plurality of cells visited by the UE during an inactive state or an idle state or in connected state; and
transmit the priority cell list to the base station.

4. The RIC (109) as claimed in claim 1, wherein the processor (201) is configured to:
determine priority of each of one or more cells based on the mobility history information, wherein the mobility history information includes information regarding amount of time spent by the UE in the one or more cells, number of times the UE visited in the one or more cells and traversal pattern of the UE among the one or more cells.

5. The RIC (109) as claimed in claim 1, wherein the mobility history information and the subscriber ID are received by the RIC from the base station using one of a first message and a second message via E2 interface.

6. The RIC (109) as claimed in claim 1, wherein the priority cell list and the subscriber ID are transmitted to the base station using a first message via E2 interface.

7. The RIC (109) as claimed in claim 1, wherein the priority cell list and the subscriber ID are transmitted to the base station using a second message via E2 interface.

8. A method, comprising:
receiving, by a Radio Access Network (RAN) Intelligent Controller (RIC) (109), a mobility history information of a User Equipment (UE) and a subscriber identifier (ID) of the UE from a base station, wherein the base station is where the UE is connected;
storing, by the RIC (109), the mobility history information of the UE based on the subscriber ID of the UE; and
determining, by the RIC (109), a priority cell list based on the mobility history information of the UE.

9. The method as claimed in claim 8, comprising:
mapping, by the RIC (109), the mobility history information with the subscriber ID of the UE; and
storing, by the RIC (109), the mapped mobility history information for determining the priority cell list.

10. The method as claimed in claim 8, comprising:
determining, by the RIC (109), the priority cell list based on the mobility history information, wherein the mobility history information of the UE comprises information regarding one or more cells of a plurality of cells visited by the UE during an inactive state or an idle state or in connected state; and
transmitting, by the RIC (109), the priority cell list to the base station.

11. The method as claimed in claim 8, wherein determining the priority cell list comprises:
determining, by the RIC (109), priority of each of one or more cells based on the mobility history information, wherein the mobility history information includes information regarding amount of time spent by the UE in the one or more cells, number of times the UE visited in the one or more cells and traversal pattern of the UE among the one or more cells.

12. The method as claimed in claim 8, wherein the mobility history information and the subscriber ID are received by the RIC from the base station using one of a first message and a second message via E2 interface.

13. The method as claimed in claim 8, wherein the priority cell list and the subscriber ID are transmitted to the base station using a first message via E2 interface.

14. The method as claimed in claim 8, wherein the priority cell list and the subscriber ID are transmitted to the base station using a second message via E2 interface.

15. A base station (107) comprising:
a memory (405) configured to store instructions executable by a processor (401); and
the processor (401) configured to execute the instructions stored in the memory (405) and thereby cause the base station where a User Equipment (UE) is connected to:
receive a mobility history information of the UE and a subscriber identifier (ID) of the UE from the UE;
transmit the mobility history information and the subscriber ID of the UE to a Radio Access Network (RAN) Intelligent Controller (RIC);
receive a priority cell list from the RIC, wherein the RIC determines the priority cell list based on the mobility history information of the UE; and
perform paging based on the priority cell list.

16. The base station (107) as claimed in claim 15, wherein the processor (401) is configured to:
receive an Information Element (IE) from the UE, wherein the IE indicates availability of the mobility history information;
transmit a request message to the UE for sharing the mobility history information of the UE; and
receive the mobility history information of the UE in response to the request message.

17. The base station (107) as claimed in claim 15, wherein the paging is performed when at least one of signaling message or data is received by the base station for the UE during an inactive state.

18. The base station (107) as claimed in claim 15, wherein the mobility history information of the UE comprises information regarding one or more cells of a plurality of cells visited by the UE during an inactive state or an idle state or in connected state.

19. The base station (107) as claimed in claim 15, wherein the processor (401) is configured to:
set a timer for a predefined time period; and
perform the paging in one or more cells based on at least one of successful paging or the paging in one or more cells based on next highest priority of the priority cell list within the predefined time period.

20. A non-transitory computer readable medium including instructions for performing operation comprising:
receive a mobility history information of a User Equipment (UE) and a subscriber identifier (ID) of the UE from a base station, wherein the base station is where the UE is connected;
store the mobility history information of the UE based on the subscriber ID of the UE; and
determine a priority cell list based on the mobility history information of the UE.
